(19) United States
(12) Patent Application Publication
(10) Pub. No.: US 2020/0013129 A1
(43) Pub. Date: Jan. 9, 2020

(54) METHOD AND DEVICE FOR POOLING INTELLECTUAL PROPERTY ASSETS FOR SECURITIZATION

(71) Applicant: David Pullman, Los Angeles, CA (US)

(72) Inventor: David Pullman, Los Angeles, CA (US)

(21) Appl. No.: 16/574,328

(22) Filed: Sep. 18, 2019

Related U.S. Application Data
(63) Continuation of application No. 14/714,482, filed on May 18, 2015, now abandoned.
Application No. 14/714,482 is a division of application No. 10/159,344, filed on May 31, 2002, now abandoned.

(51) Int. Cl. G06Q 50/18; G06Q 10/00

(52) U.S. Cl. CPC G06Q 50/184; G06Q 10/00

(57) ABSTRACT

A method for creating a pool of intellectual property assets for securitization provides for identifying rights to each of a plurality of intellectual property assets including a first intellectual property asset and a second intellectual property asset, the rights including first rights corresponding to a first revenue stream and second rights corresponding to a second revenue stream. Revenues in the first revenue stream associated with the first intellectual property asset are identified so as to define first asset first revenues, and revenues in the second revenue stream associated with the first intellectual property asset are identified so as to define first asset second revenues. A diversified pool of assets for securitization is created by approaching a desired ratio between the first pool revenue stream and the second pool revenue stream. An alternative method using predetermined minimum revenue amounts is also included.

### This is a Continuation of U.S. patent application Ser. No. 14/714,482, filed May

18, 2015 which is a Divisional of U.S. patent application Ser. No. 10/159,344, filed May 31, 2002, both of which are hereby incorporated by reference herein.

### BACKGROUND OF THE INVENTION

The present invention relates generally to methods and devices for valuing intellectual property assets, and more particularly to methods and devices for securitizing such assets.

Intellectual property assets, based for example on underlying copyright, patent, trademark or trade secret rights, often provide revenue streams that may continue for several years. For example, a music copyright to a certain song may be the underlying basis providing a songwriter, a recording artist, a publisher and a record company with a stream of revenue from various royalties. Among these royalties may be publishing royalties, mechanical royalties, performance royalties, synchronization royalties and artist royalties. An intellectual property asset of a songwriter thus may include the writer's share of publishing rights and performance royalties for various songs protected by copyright.

The owner of a patent who has licensed the patent may receive royalty streams from licensees of that patent in different geographic regions of the country in which the patent is held, for different fields of use of the invention. The royalty streams may include fixed periodic payments as well as payments based on sales of products incorporating the invention. The owner may hold patent rights in several different countries for the same invention, and therefore may receive royalty streams from domestic and foreign uses of the invention. The owner of trademark or trade secret rights may similarly have several categories of revenue streams based on his rights to that intellectual property. The revenue streams may include various types of licensing payments in categories similar to those for a patent license.

In contrast to traditional asset-backed securities involve, such as auto loan agreements or property mortgages in which the rights to receivables are clearly defined, securities based on intellectual property royalties often involve receivables which are not fully known. Thus, determining the quality of the asset includes both the risk that the anticipated receivables are not generated, as well as the risk that the generated receivables will not be collected. Securitization transactions based in intellectual property assets thus may require extensive analysis and due diligence.

For various financial reasons, securitization of intellectual property assets may be advantageous. In simplified form, securitization of intellectual property rights operates as follows: the owner of certain royalty rights sells interest-bearing notes to noteholders, with notes being backed by the future royalty stream. Thus, the owner receives an up-front payment, and in exchange, the owner agrees that the future royalty payments will pay off the principal and interest due to the noteholder.

The actual legal and financial structure for an intellectual property securitization however is much more complicated. The original right holder, or right holders, typically will transfer the intellectual property rights to a special purpose entity (SPE), which will then issue the notes. The SPE pays the original right holders for the purchase of their rights, collects the money from purchasers or investors in the notes, collects royalties, and pays the interest and principal of the notes. Once the notes are paid, the royalty rights may revert to the original right holders.

Purchase of the assets by the SPE and ratings agencies also require that title to the intellectual property assets be clear of any liens or other security interests. This process may be complicated and require review of assignments filed with various governmental agencies, for example the copyright office. UCC clearances may also be required. The transaction costs for clearing title to a single song, for example, may exceed $100.

U.S. Patent Application No. 2001/0042034, which is hereby incorporated by reference herein, provides a general description of securitizing intellectual property assets. This application seeks to provide a means whereby holders of intellectual property may more rapidly determine the real-time value of their intellectual property assets by collecting real-time information from multiple investors. The entire process is automated to create an electronic marketplace, so that multiple investor accounts can be used to continuously evaluate the value of underlying intellectual property assets. However, automated valuation methods, automated due diligence, and prefunding at present are not realistic in the current securitization market, and the application, which is not necessarily prior art to the present invention, does not address many issues related to intellectual property securitization as it currently functions. For example, many of the factors addressed in the application are not taken into consideration by ratings agencies, for example development costs.

### SUMMARY OF THE INVENTION

An object of the present invention is to provide a method and device for lowering the costs associated with securitization of intellectual property assets.

Another alternate or additional object of the present invention is to provide a method and device for improving ratings of notes backed by intellectual property assets.

A major concern in securitizing intellectual property assets lies in the uncertainty underlying the future payments. When the royalty payments are not fixed or do not have a minimum, as is often the case in music payments, predicting the future revenue stream from the assets often is difficult. While general pooling, for example by music class, has been suggested as a way to minimize these risks, in practice it has not been able to be achieved due to various difficulties, such as due diligence costs and the difficulty in determining desired pool characteristics.

The present invention provides a method creating a pool of intellectual property assets for securitization comprising the steps of:

identifying rights to each of a plurality of intellectual property assets, including a first intellectual property asset and a second intellectual property asset, the rights including first rights corresponding to a first revenue stream and second rights corresponding to a second revenue stream;

identifying revenues in the first revenue stream associated with the first intellectual property asset so as to define first asset first revenues, and identifying revenues in the second revenue stream associated with the first intellectual property asset so as to define first asset second revenues;

identifying revenues in the first revenue stream associated with the second intellectual property asset so as to define second asset first revenues, and identifying revenues in the second revenue stream associated with the second intellectual property asset so as to define second asset second revenues;

selecting at least the first intellectual property asset and the second intellectual property asset from the plurality of the intellectual property assets to form a pool of intellectual property assets to be securitized, the pool having a first pool revenue stream including the first asset first revenues and the second asset first revenues and a second pool revenue stream including the first asset second revenues and the second asset second revenues, the first asset and the second asset being selected so as to approach a desired ratio between the first pool revenue stream and the second pool revenue stream.

The present invention thus provides a method for diversifying a pool of assets by focusing on different revenue streams, and creating a pool of assets that have a desired mixture of those revenue streams.

Preferably, the first and second intellectual property assets are copyright-based, for example music-revenue based. The first revenue stream preferably includes revenues based on U.S. rights and the second revenue stream based on foreign rights. Thus, if it may be desired that the pool have a 2:1 ratio of U.S. (first) rights to foreign (second) rights. If the first music asset had first asset first revenues of $300,000 and first asset second revenues of $100,000, the second asset is chosen that has second asset first revenues in a ratio of less than 2:1 with respect to the second asset second revenues, for example with second asset first revenues of $150,000 and second asset second revenues of $100,000. The pool ratio thus is 450,000:200,000 or 2.25:1, approaching the desired ratio of 2:1.

Depending on the targeted purchasers of the securitization products, pools can thus be created to achieve the proper revenue ratio desired by the pool creator. For example, a rating agency may express the desire that revenues be balanced geographically, by music type, by asset type (mechanical royalties versus synchronization royalties, for example), in order to achieve a certain rating. The present method permits the pool creator to balance these revenues to create desired revenue ratios.

Preferably, the selection process includes selecting more than the first and second intellectual property assets from the plurality of intellectual property assets. Most preferably, the assets are music assets and the number of assets selected is between 20 and 500. Due to due diligence costs, and the cost of identifying and evaluating music assets, and also due to the low revenues of some intellectual properties, the present applicant has found that this number of assets is preferable to provide adequate diversification of a music asset pool without creating excessive due diligence costs.

Preferably, the rights include rights to more revenue streams than just the first revenue stream and the second revenue stream, and the ratio between all of the streams can be selected to achieve a desired diversification. For example, the revenue streams may be divided between the U.S., Europe and Latin America, and a ratio of 3:2:2 can be desired to be achieved.

The method of the present invention may also be used to achieve diversification in asset type, for example the first revenue stream may be for rhythm and blues and the second for rock and roll. Thus, a first asset may have zero revenues in one of the revenue streams. Also, music assets could be combined with other intellectual property assets, such as patent licensing rights, to create diversification in this manner.

Preferably, the present invention may include the step of purchasing rights to the plurality of intellectual property assets prior to the selecting step. Thus a warehouse of rights can be established from which to select the intellectual property assets.

### BRIEF DESCRIPTION OF THE DRAWINGS

The following figures show a preferred embodiment of the present invention in which:

FIG. 1 shows a schematic diagram of a intellectual property-based securitization transaction at the outset of the transaction according to the present invention;

FIG. 2 shows a schematic diagram of the transaction of FIG. 1 during the term of the transaction;

FIG. 3 shows a flowchart of a method of securitizing music intellectual property assets according to a preferred embodiment of the present invention;

FIG. 4 shows a flowchart of a method of creating a pool of music intellectual property assets according to a preferred embodiment of the present invention;

FIG. 5 shows a simplified spreadsheet with revenues from a plurality of intellectual property assets for the past five years;

FIG. 6 shows a simplified spreadsheet with the revenues from the FIG. 2 spreadsheet divided into three revenue streams for each of the five years;

FIG. 7 shows the simplified spreadsheet of FIG. 3 with the revenues for each of the three revenue streams projected into the future for future years 1 to 5, based on past revenues, and with varying expirations for the different revenue streams, with green US rights expiring in 2005, and red Asian rights expiring in 2004.

FIG. 8 shows a pool of assets selected from the intellectual property assets to achieve a ratio of X:Y:Z for the three revenue streams; and

FIG. 9 shows a device for creating the pool of assets.

### DETAILED DESCRIPTION OF A PREFERRED EMBODIMENT

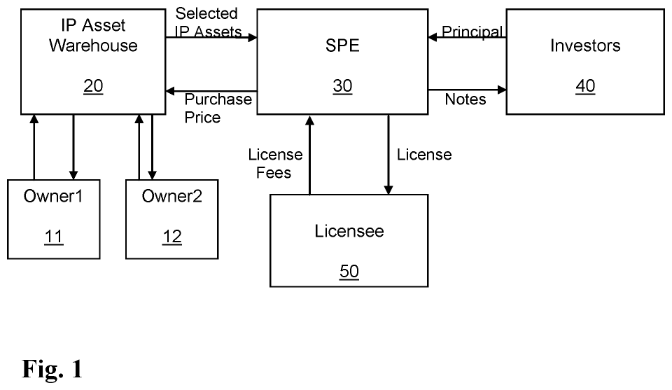

FIG. 1 shows, in schematic form, a preferred embodiment of the present invention in which a warehouse 20 is used to collect and store intellectual property assets from various intellectual property asset owners 11, 12. Owners 11, 12 may be for example music publishers, songwriters, performers, or other persons deriving revenue from underlying copyrights. Owners 11, 12 could also be patent or trademark owners, for example. Typically many more than the two owners 11, 12 will transfer rights to the warehouse. In an alternate embodiment, a single owner with a large number of assets can directly transfer rights in a pool of assets to the SPE 30.

Owners 11, 12 assign the rights in the asset or assets to warehouse 20, which in turns pays the owner 11, 12 a purchase price for the assets. From the warehoused IP assets, a selected pool of assets is chosen, and transferred to a bankruptcy-remote special purpose entity (“SPE”) 30, which pays the IP asset warehouse for the rights. The assignments between the owners 11, 12, the warehouse, and the SPE preferably all take form of a true sale between the parties.

SPE 30 issues securities (“notes”) to one or more investors 40 in exchange for a principal amount. SPE 30 may take the form of a trust, which holds the IP assets for the benefit of the investors 40 for the term of the transaction. SPE 30 may license rights to the intellectual property to one or more licensees 50 in return for a license fee, as shown in FIG. 1. Alternately, SPE 30 obtains preexisting license rights from the owners 11 or warehouse 20, so that SPE 30, by virtue of the transfer of property from the warehouse 20, will have rights to the royalty streams that had previously been directed to the warehouse 20.

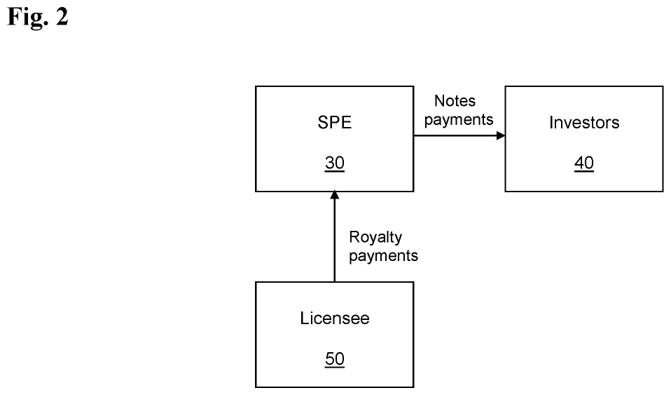

During the term of the transaction, as shown schematically in FIG. 2, the royalty streams are collected by SPE 30, instead of by the original owner 10. The royalties are paid to the SPE either by the Licensee, if, for example patent rights were licensed by the SPE, or, in the case of existing royalty obligations, by an entity or entities that are set up to collect royalties.

The notes may have a set interest rate and a set term for repayment of the principal. For example, the notes may have a face value of $10,000,000 at 10% interest with a 15-year term, payable in yearly installments. The bonds are self-amortizing, so that license fees received by SPE 30 pay the interest and reduce the principle each payment. If the license fees exceed expectations, the bonds thus are retired earlier than the set term. For example, the revenues received by SPE 30 the first year may be $2,020,000, and net management costs for SPE 30 are $20,000. SPE 30 thus pays the investors $2,000,000, with $1,000,000 paying the first interest installment and another $1,000,000 paying down the principal. A balance of $9,000,000 remains, so that the SPE will owe $900,000 in interest for the second year. If in the second year, another $2,020,000 is received by the SPE from licensees 50 and the management costs remain $20,000, the SPE pays $2,000,000 to the investors 40. $900,000 pays the second year interest, and $1,100,000 goes to principal repayment, resulting in a remaining balance of $7,900,000. If payments from SPE 30 to investors 40 remain at $2,000,000 year, the notes retire with a final payment at the end of year 8, with the principal at the end of years 1, 2, 3, 4, 5, 6, 7 and 8 being the following: $9,000,000; $7,900,000; $6,690,000; $5,359,000; $3,894,900; $2,284,390; $512,829, $0. A balance at the end of year 8 of $1,435,888 remains with SPE 30.

In a music-backed transaction, for example, the royalties originally due to a music publisher/owner 11, and now owed to SPE 30, may be collected by a record company/licensee 50 and distributed to SPE 30. SPE 30 uses the collected royalty revenue to pay the interest and principal on the notes to investors as it becomes due. Once sufficient funds have been collected to pay off the entire principal amount plus interest, the notes become fully paid off and cease to exist. At that point, the assets, and any remaining funds, may revert back to warehouse 20, which may then pass the rights back to owners 11, 12.

SPE 30 owns the assets, or a security interest in the assets, during the term of the transaction, and, in the case of default, (i.e. the royalty streams are insufficient to meet the scheduled the interest and principal payments on the notes), SPE 30 may liquidate the rights by selling them to a specific purchaser or at public auction.

Warehouse 20 can be used to collect a wide variety of intellectual property assets, including patent, trademark and copyright rights. Collected music rights may include publishing, mechanical, performance, synchronization, and artist royalties.

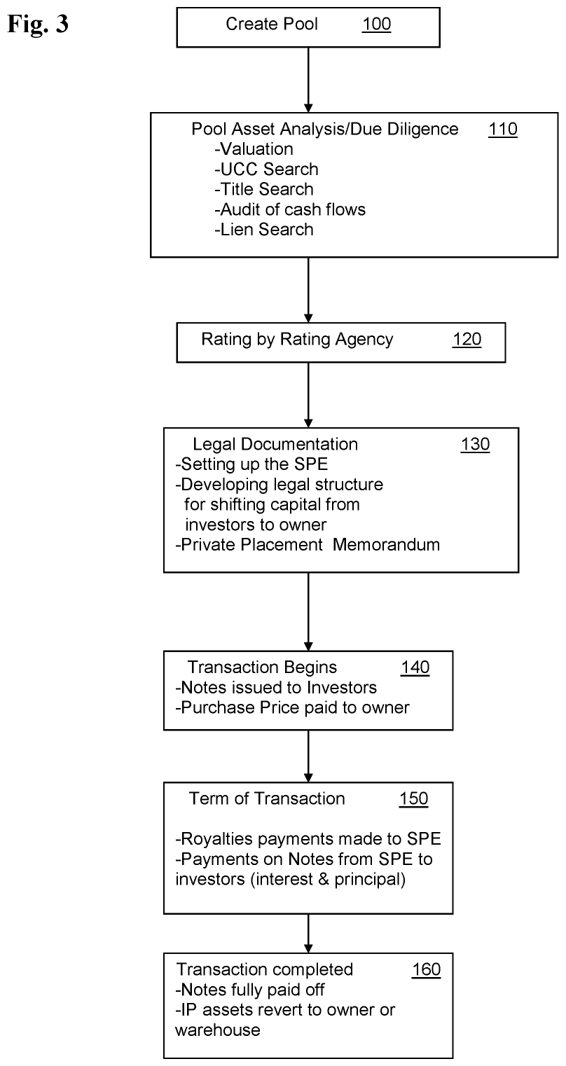

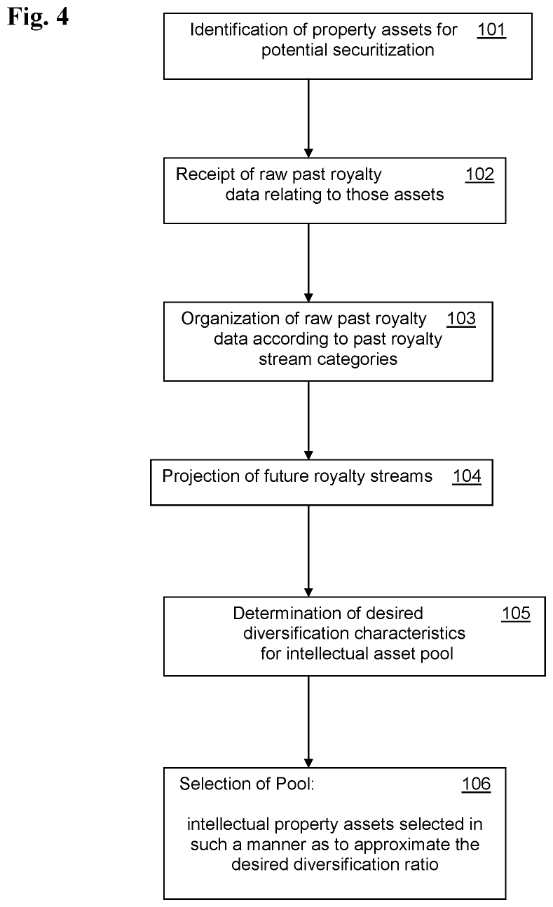

Before the transaction is structured, the present invention provides for a detailed analysis to be performed of the intellectual property assets to the securitized. FIG. 3 shows the basic flow for the securitized transaction according to the present invention. A preliminary pool of assets in step 100 is created, this pool being selected as will be described with reference to FIG. 4. The pool assets then are cleared in step 110 to ensure that title is proper, and that the actual cash flows generated by the asset are as reported. This step 110 may have already been performed by warehouse 20, although typically the assets are cleared after pool selection. Due diligence costs may exceed $100 per asset for music copyrights, so minimizing due diligence costs is advantageous.

Proper title inquiries can be made, for example through a UCC search and/or searches of the underlying intellectual property rights at the appropriate patent, trademark, or copyright offices in the relevant countries in which rights exist. In addition, expiration dates of each of the intellectual property rights must be determined. The past royalty data must be audited for accuracy. A valuation of the assets is also performed to determine their likely future value and factors that may cause substantial deviations of the estimated future value. Valuation includes both projecting future royalty revenue streams, as well as determining a fair market value for the rights as a whole, or a value that a specific buyer may be willing to pay for an ownership interest in the rights. In addition, the credit worthiness of each of the parties in the transaction must be evaluated, and the processes by which receivables will be collected and transferred to SPE 30. If the pool creation step 100 is a function not only of past revenues, but a function of future revenues as well, the valuation step may be performed prior to step 100.

Prior to the issue of the notes by the SPE, it is typically desired to have the transaction rated in step 120 by a rating company such as Moody's, Standard & Poors, or Duff & Phelps. These companies will perform independent analyses of the transaction in order to quantify the amount of risk and assign a rating to the transaction. The rating indicates to potential investors the amount of risk associated with the notes, and in turn, the level of interest that the investors will demand in exchange for the notes. Because of the complexity involved in quantifying the risk of these transactions, it often is impossible to attract investors without a positive rating. The pool characteristics and analysis of steps 100 and 110 are presented to the rating agency for the determination. A clear and understandable presentation of the pool royalty structure is important for obtaining an advantageous rating. Diversification and steady revenue streams are also desired by the ratings agencies. The present invention aids in both the presentation of information and the diversification of assets to be securitized.

In step 130, the appropriate legal documentation is prepared to set up SPE 30, to develop the legal structure for issuing the notes and shifting the principal paid by the investors 40 for the notes to the warehouse 20 or owners 11, 12 in the form of the purchase price for the assets. A private placement memorandum may be prepared for the potential investors 40. The legal documentation is shown in the flow chart as occurring after steps 110, 120, however, step 130 is preferably performed, at least in part, simultaneously with the asset analysis and ratings steps.

Once the legal documentation is completed and investors 40 identified, the transaction can begin with the near simultaneous transfer of the intellectual property assets from warehouse 20 to SPE 30 and issuance of the notes by SPE 30 to investors 40 in return for the principal payment. A substantial portion of the principal paid for the notes typically is used for the purchase price of the assets. Some of the principal may be used to pay required fees in setting up the structure and for keeping cash reserves in SPE 30.

During the term of the transaction in step 150, royalty payments are made to SPE 30 and these are used to make periodic scheduled payments of interest and principal on the notes. Once the notes are fully paid off, the transaction is completed and the ownership of the intellectual property assets, as well as any remaining cash, reverts back to warehouse 20 and SPE 30 is dissolved.

To achieve a high bond rating, the level of risk and uncertainty involved in the transaction should be minimized. Thus, for example, it is helpful to have royalty data going back several years, showing that the assets, at least in the past, have had a particular quantifiable value. From the past royalty data, one can estimate anticipated future royalties using an anticipated growth rate, as well as other criteria, taking into consideration any expiration of the rights during the term of the transaction. It may be easier to extrapolate anticipated future royalties from past royalty data showing low levels of volatility over the years. If the trend in the past data shows the value to be increasing year over year, that may further mitigate against risk. In addition to choosing assets of high perceived value and low volatility, one way to further reduce risk is to create the pool of several intellectual property assets having diverse characteristics, so that if one asset does not perform as expected, that underperformance may, at least in part, be cancelled out by the overperformance of another asset in the pool. Therefore, step 100 shown in FIG. 3, that of creating the pool, is performed so as to achieve a diversified pool.

While in the past it has been suggested to pool assets, for example, in the music field to mix rhythm and blues, country and rock and roll revenues to diversify the pool, this in practicality has difficult to achieve and present in a manner that increases a rating.

With the present invention, the assets may be chosen according to their multiple specific royalty stream categories in order for the pool to approximate specific predetermined diversity characteristics, such as a desired ratio between the specific royalty stream categories.

FIG. 4 shows a schematic flow chart illustrating steps of the preferred embodiment that are preferably performed so as to create a pool of intellectual property assets according to a desired diversification ratio based on revenues. In step 101, intellectual property assets for potential securitization are identified, such as those owned by warehouse 20. Alternately, the method of the present invention could be used with a large publishing house, for example, or a large corporation having multiple licensed patents. Past royalty data for those assets is received in step 102, either from owners 11, 12, warehouse 20, or from organizations that track royalty information on such assets as rights to music, for example.

In step 103, past royalty data is organized into different categories of royalty streams individually for each of the assets. There are many potential categories for royalty streams, as discussed above. For music-based assets, the categories of revenue streams may include mechanical, performance, and synchronization royalties, or different music types. The assets may include a mixture of different types of intellectual property, in which case the royalty streams could also be divided according to the type of intellectual property. In many situations, an asset may have a value of zero for a particular royalty stream category. The actual categories chosen may include many, or as few as two, such as, for example, U.S. and non-U.S. royalties. As shown in FIG. 4, once the past royalty data has been organized accordingly, a future royalty stream may be projected for each asset in step 104.

The future royalty streams are projected, in part, based on past royalty streams. Expiration of underlying intellectual property rights is taken into account, as well as any other known, or knowable factors that might significantly alter the future royalty streams for each particular asset. For example, U.S. mechanical royalties increase statutorily at a known rate, and can be accounted for to provide for increased future royalty rates. General industry growth rates may be taken into account as well.

Depending in the number of assets and the difficulties in projecting future royalty stream data, step 104 may or may not be performed before the pool is created. If for example the number of assets being considered is high and/or the effort involved in projecting future royalty streams is high, this step may be omitted (and be performed later only on the reduced number of assets that are actually chosen for the pool). If step 104 of projecting future royalties is omitted, step 105 of selecting intellectual property assets for the pool is performed based on past royalty stream data, and the future revenues projected later, for example in step 110.

Once the royalty data is properly organized, specific intellectual property assets are selected for the pool based on the royalty streams in step 106. The royalty streams may be projected future royalty data, or, of the projection step is omitted, they may be past royalty streams.

According to the method illustrated in FIG. 4, a desired diversification ratio may be determined for the pool. Although this step follows the projection step in FIG. 4, the desired ratio may be determined at any time before the selection of the pool. The diversification ratio is the relationship between royalty stream values for at least two of the different royalty stream categories that were organized in the organization step 103.

A pool royalty stream ratio is the relationship between the sum of the revenue streams for the pool assets for one revenue stream category and the sum of the revenue streams for the pool assets for another revenue stream ratio. The selection of the assets for the pool is made with the royalty ratio of the selected asset in mind so that the total pool royalty ratio, whether for past or future revenues, or for a combination, approaches the desired diversification ratio.

The invention will now be described in greater detail in accordance with a simplified example of a specific transaction involving rights to royalties for musical compositions.

FIG. 5 shows a simplified spreadsheet with revenues from a plurality of intellectual property assets for the past five years (1997-2001) selected from warehouse 20, and each having a past revenue of at least $5,000 over the last 5 years. In this example, the intellectual property assets relates to songs, with the titles listed in schematic form as blue, red, green, yellow, and orange. The revenue amounts are broken down by song title and year. In practice, for example, the songs can be pre-selected from the warehouse so that a broad pre-pool of, for example 1000 songs is established, with these songs being pre-selected for example on the basis of a minimum past 5-year royalty performance. Each song may have generated for example a minimum of $10,000 in revenues in the past 5 years, for example.

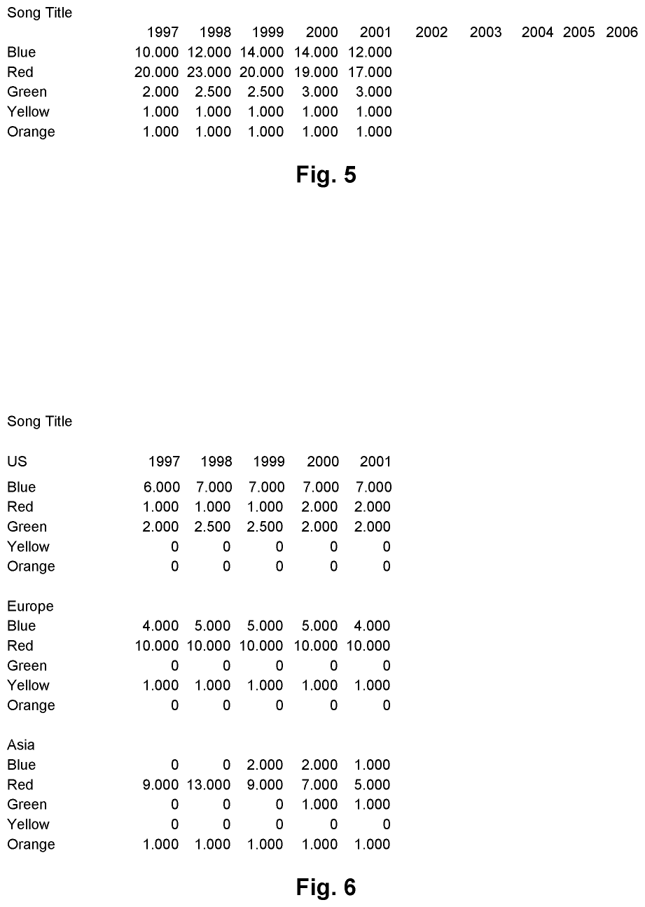

In FIG. 6, the revenue amounts shown in FIG. 5 are further broken down by royalty stream category for each year. In this example, the categories chosen are U.S.-derived revenues, Europe-derived revenues and Asia-derived revenues. For each song the sum of the categories in each year is equal to the total royalties derived for that song in a particular year, as shown in FIG. 5. These categories can be broken down even further, so that revenue streams of the individual countries of Europe, including Great Britain, Ireland, Norway, Sweden, Denmark, Finland, Poland, Germany, the Netherlands, Belgium, Luxembourg, France, Spain, Portugal, Italy, Switzerland, Austria, Liechtenstein, Slovenia, the Czech Republic, Slovakia, Hungary, and Romania, are itemized. Revenue streams for Latin America and Canada may be included as well.

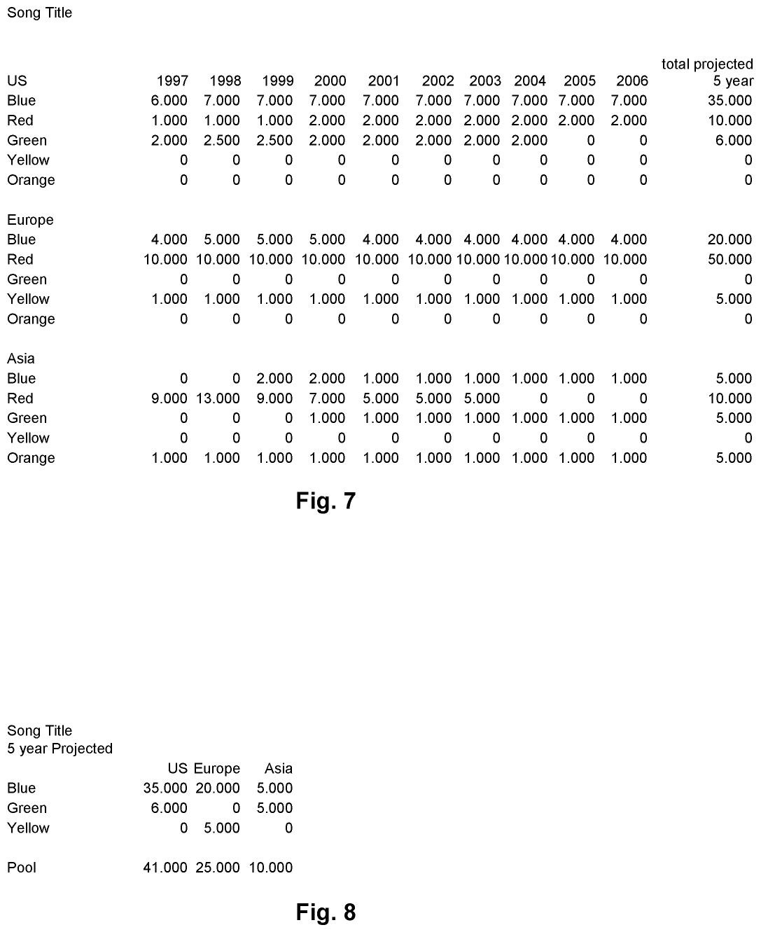

FIG. 7 shows projected revenues for the next five years (2002-2006) for each category and song using the data in FIG. 5, and includes the total projected revenues for the projected five-year period. The projected revenue values in FIG. 6 are based on past revenue amounts and account for expiration dates for the underlying copyrights in the songs. Thus, for example, the U.S. copyrights to the green song expire in 2005 and the Asian copyrights to the red song expire in 2004.

In practice, the projection of the royalties will be much more detailed. Industry growth rates for each country may be used to project a growth rate for each region. Past trends for each song, downward or upward, can be used to alter the future revenues, or the past trend for the entire group of songs can be used.

The mechanical royalties, performance and synchronization royalties, if rights to such royalties exist, can be broken out, and statutory or other known growth rates applied to each of these categories.

In the example shown in FIG. 7, the revenues are projected based on the known factors. For example, in the U.S. the future revenues may be projected on the basis of the 2000 year royalty, as growth rates in the US may be increasing, and these estimates thus are conservative. The rights to Green however expire in 2005.

In Europe, the projected revenues may be based on the lowest of the last 5 year revenue period, as the growth rates may not be as great and this projection is acceptable as conservative to a rating agency.

In Asia, the projection may be based on the lower of 2000 and 2001 revenues, as the industry has accepted this as a reasonable conservative approximation based on past experience. Rights to Red in Asia however expire in 2005.

The actual projections will vary by the type of asset and the detail provided. More accurate assumptions, or assumptions that can be supported rationally, will generally support higher bond ratings. The present invention, in displaying and accommodating presentation of detailed data in simplified form aids in obtaining favorable bond ratings.

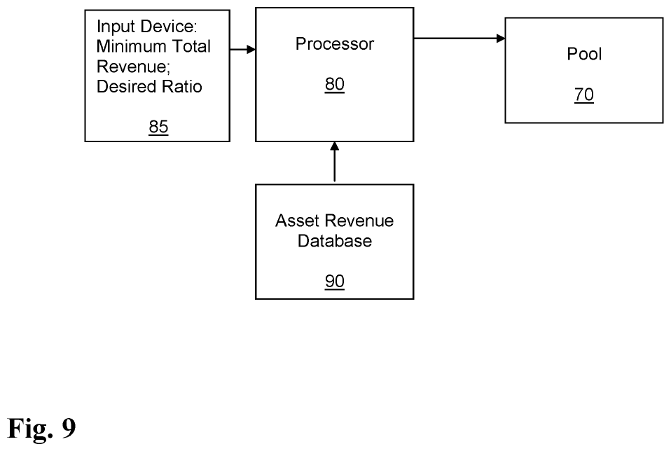

As shown in FIG. 9, an input device 85, for example a keyboard or a client computer can be used to set a desired ratio between the US, European and Asian revenues for a pool. A minimum total revenue for the pool can be set as well, as can a minimum number of assets. For example, a ratio of 8:5:2 may be selected for future projected five year U.S. revenues to European revenues to Asian revenues.

A processor 80 receives the input and a pool selection program may form groups of assets from database 90, the group of assets having more than the minimum total revenue and more than the minimum number of assets. The group most closely resembling the desired ratio may then be selected. Preferably, the processor uses a least squares method to select the group, so that the sum of the squares of the deviations from the ratio is minimized. In one embodiment, the ratio for each group can be zeroed about the lowest integer for the desired ratio.

Referring to FIG. 7, the US:Europe:Asia ratio of each song is as follows: Blue 35:20:5, Red 10:50:10, Green 6:0:5, Yellow 0:5:0, and Orange 0:0:5. A minimum of three songs is set, and a minimum total pool revenue of $50,000. The following groups thus are examined for consideration: BRG, BRY, BRO, BRGY, BRGO, BRGYO, BGY, BGO, BGYO, RGY, RGO, RGYO, as all have at least three songs generating a projected revenue of at least $50,000. BRG provides a revenue ratio of 51:70:20, reduced to 5.1:7:2 to zero the lowest integer. A mean square deviation of (5.1−8)*(5.1−8)+(7−5)*(7−5)=12.41 is obtained. For BYO, with a ratio of 35:25:10, or 7:5:2, a mean square deviation of (7−8)*(7−8)+(5−5)*(5−5)=1 is obtained. For the combination BGY, providing a ratio of 41:25:10, or 8.2:5:2, a mean square deviation of (8.2−8)*(8.2−8)+(5−5)*(5−5)=0.04 is obtained.

After all the mean squares are compared, the lowest, or one having a deviation between a certain predetermined level to minimize computational time, is selected to form the pool 70. A diversified pool can thus be selected automatically from a large group of using processor 80.

FIG. 8 shows the pool BGY having a deviation of 0.04 being selected as the pool of assets to be securitized, thus creating the pool 70 as in step 100 of FIG. 3. The steps 110 to 160 may then be performed. If valuation or due diligence issues surface, new assets can be sought to match the asset removal or revisions caused by step 110.

While the example has been shown with respect to geographical revenue differences, any number of pool characteristics can be set to provide diversified pools. For example, a diversified balance of mechanical, synchronization and performance revenues can be provided. Also, different asset classes, including patent and copyright revenues could be diversified.

As an alternative to the least square method, the processor could also choose pools that provide a minimum revenue for each category.

A maximum number of pool assets also can be set, as due diligence costs can be minimized thereby.

Depending on the number of songs to choose from, and the range of royalty stream values, the first asset may alternatively be chosen according to overall total value and without regard to its royalty stream ratio. Likewise, the initial pool may be selected according to the most valuable five or ten assets to choose from without regard to the desired pool ratio and with subsequent selections being made to approximate the desired pool ratio. Alternatively, selections may be made to the first and/or subsequent assets according to a criteria formula that gives weight both to the desired pool ratio to be achieved and to the overall value of the asset being chosen.

The process of creating a pool for a typical actual transaction is more complicated than the simplified example illustrated in FIGS. 5-8. Typically, projections are made over longer periods, and involve a vastly greater number of intellectual property assets. Royalty streams in upward of 150,000 musical compositions may be identified for potential securitization, for example. The pool may be created by reviewing the 150,000 titles reviewed and preferably selecting 20 to 500 for the pool. However, many more or all the titles may be chosen, if the desired diversification is achieved. A pool size of 20 to 500 titles may however be preferable because it is low enough so that the required analysis and due diligence for each of the assets in the pool is kept to a manageable and affordable amount, and yet high enough to achieve a reasonable level of diversification.

Once the pool has been created according the present invention, the pool assets are analyzed in greater detail. The valuation of the assets (step two in FIG. 3) is typically performed involving a greater degree of analysis than the projecting of future royalties for the purpose of selecting assets for the pool.

In the valuation of assets in the pool growth rates may be assumed based, in part, on the past royalty data. Preferably, the future anticipated revenue is be projected for each of the assets in the pool using more than one growth rate, such as, for example, a moderate growth rate, a conservative growth rate, and a minimal growth rate. The three estimated growth rates can then be applied to the past royalty streams for each of the assets in the pool to calculate differing future scenarios for the pool. Displaying these different scenarios, for example in a Private Placement Memorandum, can be useful for potential investors in making the decision of whether or not to invest in the notes, or for the ratings agency in determining a rating.

The present invention has particular advantages in the music industry, where the number of assets may be very high, and many assets generate low level of revenue. Diversified pools can be efficiently created.

In an alternative embodiment, the pool can be created so that the first revenue stream has a certain predetermined amount, and that the second revenue stream has a second predetermined amount. Thus rather than calculating a ratio, the minimum floors provide diversification.

While the intellectual property assets may be based for example on underlying copyright, patent, trademark or trade secret rights, they also may be based on intellectual property contractual rights or brand name rights that have continual revenue streams.

Intellectual property assets thus may include: (I) in the music field, copyrights, publisher's and writer's shares, music royalties, record masters, artist record royalties, publishing catalogues; (II) in TV & film: film libraries, television libraries, syndication rights, animation libraries, director, actor, screenwriter royalties, producer profit participation, literary catalogues and estates, authors' royalties, guild monies, such as SAG, DGA, WGA; (III) in technology areas such as high-tech or biotech: trademarks, patents, brand name merchandising, formulas; (IV) in the sports field, player contracts, team and player licenses, and endorsements; and (V) in licensing, software license streams, pharmaceutical license streams, video game license streams, biotechnology license streams, and franchise fee royalty streams, some of which may overlap with categories (I)-(IV).

What is claimed is:

1. A method for creating a pool of intellectual property assets for securitization comprising the steps of:
identifying rights to each of a plurality of intellectual property assets including a first intellectual property asset and a second intellectual property asset, the rights including first rights corresponding to a first revenue stream and second rights corresponding to a second revenue stream;
identifying, using a processor, revenues in the first revenue stream associated with the first intellectual property asset so as to define first asset first revenues, and revenues in the second revenue stream associated with the first intellectual property asset so as to define first asset second revenues;
identifying revenues, using a processor, in the first revenue stream associated with the second intellectual property asset so as to define second asset first revenues, and revenues in the second revenue stream associated with the second intellectual property asset so as to define second asset second revenues;
selecting, using a processor, at least the first intellectual property asset and the second intellectual property asset from the plurality of the intellectual property assets to form a pool of intellectual property assets to be securitized, the pool having a first pool revenue stream including the first asset first revenues and the second asset first revenues and a second pool revenue stream including the first asset second revenues and the second revenue second revenues, the first and second assets being selected so that the first pool revenue stream is at least a first predetermined amount and the second pool revenue is at least a second predetermined amount.
